(19) United States
(12) Patent Application Publication
(10) Pub. No.: US 2009/0167867 A1
(43) Pub. Date: Jul. 2, 2009

(54) CAMERA CONTROL SYSTEM CAPABLE OF POSITIONING AND TRACKING OBJECT IN SPACE AND METHOD THEREOF

(76) Inventors: Shyi-Ching Lin, Hsinchu City (TW); Jyh-Horng Wu, Taichung City (TW); Lun-Chi Chen, Kaohsiung City (TW); Hui-Hung Yu, Hsinchu City (TW)

Correspondence Address: NORTH AMERICA INTELLECTUAL PROPERTY CORPORATION, P.O. BOX 506, MERRIFIELD, VA, 22116, US

(21) Appl. No.: 12/099,775

(22) Filed: Apr. 8, 2008

(30) Foreign Application Priority Data
Dec. 31, 2007 (TW) 096151626

(51) Int. Cl. H04N 5/225

(52) U.S. Cl. 348/169; 348/E05.024

(57) ABSTRACT

A space position device capable of generating position signals according to its position in space is used in the camera control system for tracking an object. The space position device generates and transmits its position signals to a control unit every predetermined time interval. The control unit then generates control command for controlling a camera to rotate upward/downward, leftward/rightward, zoom in or zoom out according to the generated position signals such that the camera adjusts its focus on the space position device for tracking an object automatically.

### BACKGROUND OF THE INVENTION

1. Field of the Invention

The present invention relates to a camera control system and related method, and more specifically, to a camera control system capable of positioning and tracking object in space and method thereof.

2. Description of the Prior Art

Applications of monitoring include steady cameras with limited monitoring coverage and Pan/Tilt/Zoom camera (PTZ camera) with larger monitoring coverage and flexibility. The PTZ camera has gradually replaced steady camera or incorporated into the conventional monitoring system for much excellent performance.

The PTZ camera generally has two types of operations: manual control and automatic image recognition tracking. For manual control PTZ camera, most of the job is carried out by manually operation in real time. The operator watches the screen and controls the camera by using a handle device or remote controller such that the camera can monitor and track an object. It is not beyond one's expectation that extra high manpower is the cost for such kind of operation.

For PTZ camera with automatic image recognition tracking feature, the camera is capable of obtaining many still images from the monitored screen and extracting the target object by using image recognition skill. The camera can therefore move and focus on the target object to ensure that the target object constantly lies within the coverage of the screen. Automatic object feature tracking technique, the most conventional and long-studied technique in the prior art tracking skills, can extract the image characteristic of the target object from the still images using feature extraction and feature matching and then lock and follow the target object based on the image characteristic of the target object. The image characteristic of the target object, however, does not always remain constant as the background of the monitored area changes when the target object moves. Continuous scanning of the PTZ camera also increases the difficulty of effective feature matching.

Another object tracking technique in the prior art utilizes two cameras, which use epipolar rule, to find the projection fundamental matrix for locking and tracking the target object from the feature points of the corresponding imaging surface. When one of the cameras is scanning and rotating, the corresponding imaging surface changes accordingly, which affects the configuration relation between the two cameras. It is concluded to be uneasy for outputting exact feature points by epipolar rule.

Additionally, some particular situations show that tracking of the target object is more important than monitoring of the target object. In some large briefing or speech situations, for example, screens transmitted by the camera should be close-up shot of the person who is speaking. If the object been tracked by the camera changes from the speech deliverer or briefing presenter to one of the audience or other participant, automatic image tracking in the prior art faces difficulty in precise switching between complicated dynamic objects and exact focus on the target. Manual control of the camera is still suitable for such conditions in the prior art.

### SUMMARY OF THE INVENTION

The present invention provides a camera control system capable of positioning and tracking object in space. The camera control system comprises a position device for generating and transmitting a position signal according to its position in space, a receiver for receiving the position signal transmitted by the position device, a control unit coupled to the receiver for generating a control command according to the position signal received by the receiver, and a camera coupled to the control unit wherein the control command is for controlling the camera moving its focus.

The present invention also provides a camera control method for positioning and tracking object in space. The camera control method comprises steps: generating and transmitting a position signal according to a position device's position in space; generating a control command according to the position signal; and moving a camera's focus according to the control command.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is an illustration of a first exemplary embodiment of the camera control system capable of positioning and tracking object in space according to the present invention.

FIG. 2 is an illustration of a second exemplary embodiment of the camera control system capable of positioning and tracking object in space according to the present invention.

FIG. 3 is an illustration of flow chart of the camera control method capable of positioning and tracking object in space according to the present invention.

### DETAILED DESCRIPTION

The present invention utilizes a space position device capable of generating corresponding position signal in space according to its position in space as a tracking basis for controlling a camera. The camera control system therefore can have real-time control of the camera to track the space position device. For example, in an exemplary embodiment of the present invention, the space position device is configured on a microphone held by a speaker (wire or wireless) in a large briefing/conference occasion. The space position device moves with the microphone when the speaker moves. The camera control system can therefore track and monitor the position of the space position device. As the speaker hands over the microphone to another speaker, the camera control system of the present invention can still effectively and precisely track the different target that is speaking with the microphone equipped with the space position device.

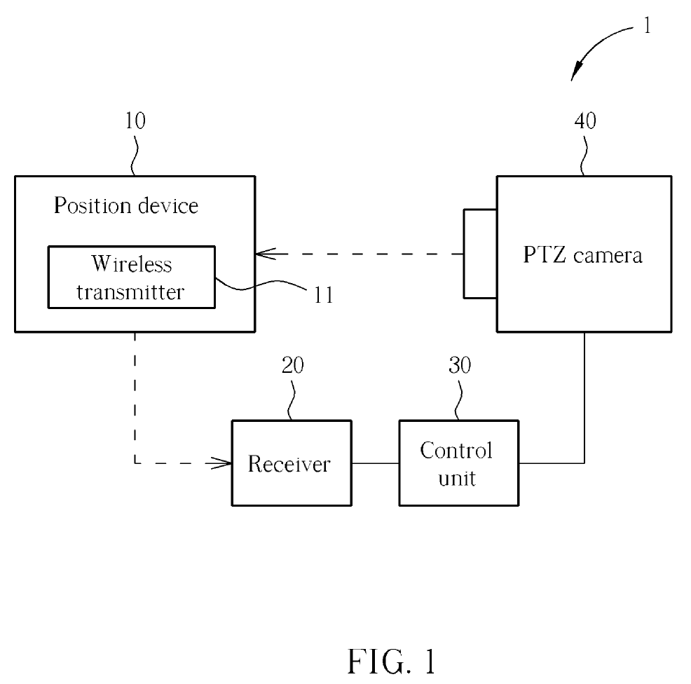

Please refer to FIG. 1. FIG. 1 is an illustration of a first exemplary embodiment of the camera control system capable of positioning and tracking object in space according to the present invention. The camera control system 1 comprises a position device 10, a receiver 20, a control unit 30, and a PTZ camera 40. The position device 10 comprises a wireless transmitter 11, which is capable of transmitting the data generated by the position device 10 via radio transmission to the receiver 20, a wireless receiver of same wireless transmission specification with the wireless transmitter 11. The receiver 20 is coupled to the control unit 30 and capable of transmitting the data received from the position device 10 to the control unit 30. The control unit 30 either converts the received data into corresponding control command for the camera 40 or generates control commands for controlling the camera 40 based on the received data. Finally the PTZ camera 40 coupled to the control unit 30 moves and focuses to the position device 10 according to the control commands.

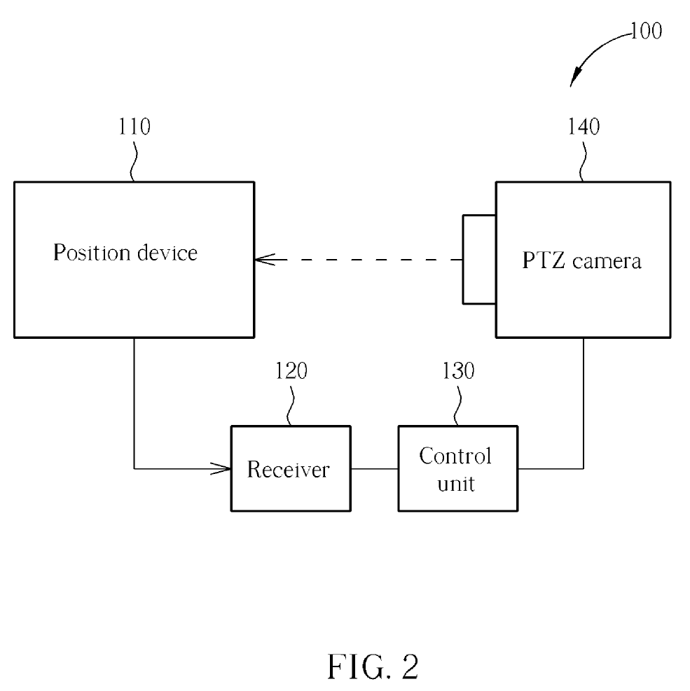

Please refer to FIG. 2. FIG. 2 is an illustration of a second exemplary embodiment of the camera control system capable of positioning and tracking object in space according to the present invention. The camera control system 100 comprises a position device 110, a receiver 120, a control unit 130, and a PTZ camera 140. Different from the first embodiment in FIG. 1, the position device 110 transmits the generated data via physical connection to the receiver 120 and the receiver 120 is coupled to the control unit 130 and capable of transmitting the data received from the position device 110 to the control unit 130. The control unit 130 either converts the received data into corresponding control command for the camera 140 or generates control commands for controlling the camera 140 based on the received data. Finally the PTZ camera 140 coupled to the control unit 130 moves and focuses to the position device 110 according to the control commands.

In the embodiments of the present invention, the position devices 10, 110 are space position devices capable of generating position signal (such as the Cartesian coordinates) according to its position in space. Generally, the position devices 10, 110 are realized by using a tracker (a position detector inside the position devices 10, 110) incorporating four references, for three dimensional data, or more than four references, for higher positioning precision. If only plane position information is required, the tracker can incorporate three references for two-dimensional data. The position information of the tracker is obtained by detecting the distances between the tracker and each reference, which therefore introduces four following techniques: (1) Signal Strength (SS): the tracker determines the distances to each reference (position source) by detecting the strength of the electromagnetic wave transmitted by each reference and finds the position of its own; (2) Angle of Arrival (AOA): the distances between each reference and the tracker are determined from the angles of sound waves or light waves transmitted by the tracker and received by the reference; (3) Time Difference of Arrival (TDoA): the references transmit sound waves or light waves to the tracker, where the sound waves or light waves are then reflected by the tracker, and the position of the tracker is obtained by calculating the time difference of arrival of the sound waves or light waves; (4) Global Positioning System (GPS): the global positioning system composed of multiple satellites can obtain the coordinates and altitude of the tracker, whose detail description of how the GPS works is known by those skilled in the art and is omitted for brevity.

Additionally, the position devices 10, 110 generate and transmit the position signals (the predefined Cartesian coordinates in space or changes of the coordinates) every certain time interval. If the position signals generated by the position devices 10, 110 are Cartesian coordinates in space, the position signals are transmitted to the receivers 20, 120 via physical connection or wirelessly (the wireless transmitter 11). The control units 30, 130 compare the received coordinates with the one of previous timestamp and obtain the moving vector of the position devices 10, 110. The angle of rotation and zooming rate of the PTZ cameras 40, 140 are then calculated according to the moving vector and converted to a control command for controlling the PTZ cameras 40, 140 to rotate upward/downward, leftward/rightward, zoom in or zoom out and focus on the position devices 10, 110. If the position signals generated by the position devices 10, 110 are changes of the coordinates, the control units 30, 130 that process the position signals directly obtain the angle of rotation and zooming rate of the PTZ cameras 40, 140 according to the changes of coordinates of every timestamp and control the PTZ cameras 40, 140 to focus on the position devices 10, 110.

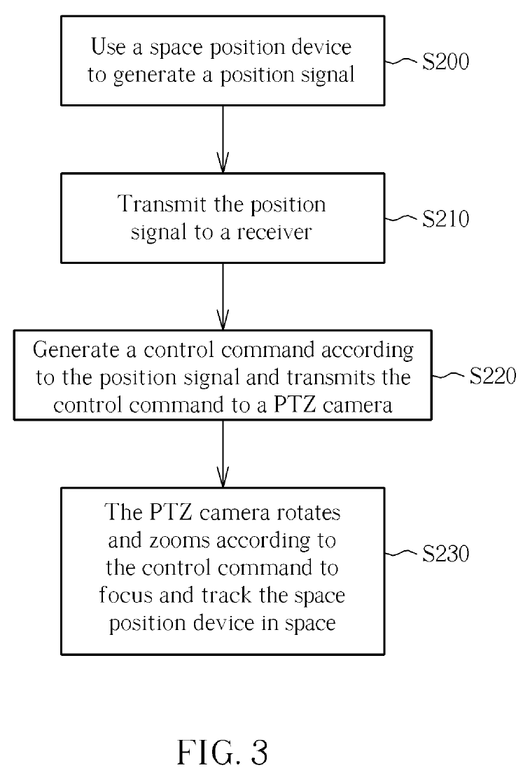

Please refer to FIG. 3. FIG. 3 is an illustration of flow chart of the camera control method capable of positioning and tracking object in space according to the present invention. The steps are as follows:

Step S200: use a space position device to generate a position signal according to its position in space;

Step S210: transmit the position signal to a receiver via physical connection or wireless connection;

Step S220: the receiver transmits the position signal to a control unit; the control unit generates a control command according to the position signal and transmits the control command to a Pan/Tilt/Zoom camera (PTZ camera); the control command includes command for controlling the camera to rotate upward/downward, leftward/rightward, zoom in or zoom out;

Step S230: the PTZ camera rotates and zooms according to the control command to focus and track the space position device in space.

The present invention utilizes a space position device capable of generating position signals according to its position in space in a camera control system for tracking an object. The space position device generates and transmits its position signals to a control unit every predetermined time interval. The control unit then generates control command for controlling a camera to rotate upward/downward, leftward/rightward, zoom in or zoom out according to the generated position signals such that the camera adjusts its focus on the space position device for tracking an object automatically.

Those skilled in the art will readily observe that numerous modifications and alterations of the device and method may be made while retaining the teachings of the invention.

What is claimed is:

1. A camera control system capable of positioning and tracking object in space, comprising:
a position device for generating and transmitting a position signal according to its position in space;
a receiver for receiving the position signal transmitted by the position device;
a control unit coupled to the receiver for generating a control command according to the position signal received by the receiver; and
a camera coupled to the control unit wherein the control command is for controlling the camera moving its focus.

2. The camera control system of claim 1, wherein the position device is a space position device capable of generating space position signal.

3. The camera control system of claim 1, wherein the position device comprises a wireless transmitter for transmitting the position signal wirelessly, the receiver being a wireless receiver for receiving the position signal wirelessly.

4. The camera control system of claim 1, wherein the position device comprises a transmitter for transmitting the position signal, the receiver receiving the position signal via physical connection.

5. The camera control system of claim 1, wherein the control unit generates the control command by obtaining the angle adjustment and the zooming rate of the camera according to the position signal.

6. The camera control system of claim 1, wherein the camera is a Pan/Tilt/Zoom (PTZ) camera.

7. The camera control system of claim 6, wherein the camera is utilized for rotating upward/downward, leftward/rightward, zooming in or zooming out according to the control command.

8. The camera control system of claim 1, wherein the camera is utilized for rotating and focusing on the position device to track the position device when receiving the control command.

9. A camera control method for positioning and tracking object in space, comprising steps:
generating and transmitting a position signal according to a position device's position in space;
generating a control command according to the position signal; and
moving a camera's focus according to the control command.

10. The camera control method of claim 9, wherein generating and transmitting a position signal according to a position device's position in space comprises: transmitting the position signal wirelessly.

11. The camera control method of claim 9, wherein generating and transmitting a position signal according to a position device's position in space comprises: transmitting the position signal via physical connection.

12. The camera control method of claim 9, wherein generating a control command according to the position signal comprises: generating the control command by obtaining the angle adjustment and the zooming rate of the camera according to the position signal.

13. The camera control method of claim 9, wherein moving a camera's focus according to the control command comprises: rotating the camera upward/downward, leftward/rightward, zooming in or zooming out.

14. The camera control method of claim 9, wherein moving a camera's focus according to the control command comprises: controlling the camera to rotate and focus on the position device to track the position device.
